(19) United States
(12) Patent Application Publication
(10) Pub. No.: US 2006/0278666 A1
(43) Pub. Date: Dec. 14, 2006

(54) Glue-stopping element for glue-coating device

(76) Inventors: Eric Wang, Kaohsiung Hsien (TW); Tz-Jie Lin, Fengshan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/235,115

(22) Filed: Sep. 27, 2005

(30) Foreign Application Priority Data
Jun. 9, 2005 (TW) 094118979

(51) Int. Cl. B67D 3/00

(52) U.S. Cl. 222/504

(57) ABSTRACT

A glue-stopping element for a glue-coating device has a driver element and a ball valve. The ball valve, which is clasped between an upper splint and a lower splint, is driven by the driver element to alternately rotate clockwise and counter-clockwise, thereby starting or stopping the glue flow quickly. A biasing ring is mounted in a ring channel in the upper splint so that when the ball valve is worn and damaged due to the extended use, the upper splint will remain abutted the ball valve due to the pressure of the biasing to prevent glue from overflowing into the periphery of the ball valve.

### BACKGROUND OF THE INVENTION

1. Field of the Invention

The present invention relates to a glue-stopping element for a glue-coating device, and more particularly to a glue-stopping element with which it is easy to start or stop the glue flow and prevent the glue from overflowing.

2. Description of the Related Art

With reference to FIG. 6, a conventional glue-coating device comprises a glue-supply barrel (81) and a base (82). The barrel (81) is mounted on top of the base (82). A piston (83) is received into the barrel (81) to push the glue downwards. The base (82) has a cylindrical cavity. A valve (84) with a circular cross section and a T-shaped passage (85) is rotatably mounted in the base (82) in the cylindrical cavity. A nozzle (86), which serves as an outlet for the glue, is mounted at the bottom of the base (82) and a filling tube (87) is provided on a side of the base (82).

In the process of glue coating, the valve (84) is rotated in a first direction, causing the barrel (81) to become connected to and communicate with the nozzle (86) through the passage (85). The glue can then flow from the barrel (81) through the passage (85) and then into and out of the nozzle (86). When the valve (84) is rotated in a second direction, the connection between the barrel (81) and the nozzle (86) is broken and the glue flow out of the nozzle (86) is stopped. Upon further rotation of the valve (84), the passage (85) connects the barrel (81) to the filling tube (87) so that additional glue can be added to the barrel (81) through the filling tube (87).

However, surface damage to the valve (84) can result from its constant rotation relative to the inner wall of the base (82), to such a degree that glue overflow into the periphery of the valve (84) can accumulate and hinder the rotation of the valve (84).

Therefore, the invention provides a glue-stopping element for a glue-coating device to mitigate or obviate the aforementioned problems.

### SUMMARY OF THE INVENTION

The main objective of the present invention is to provide a glue-stopping element for a glue-coating device, with which it is easy to start or stop the glue flow and prevent the glue from overflowing.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a glue-coating device with a glue-stoping accordance with the present invention;

FIG. 2 is a perspective view in partial cross section of the glue-coating device with the glue-stopping element in accordance with the present invention;

FIG. 3 is an exploded perspective view of the glue-stopping element for the glue-coating device in accordance with the present invention;

FIG. 4 is a perspective view of the glue-stopping element for the glue-coating device in accordance with the present invention; and

FIG. 5 is a sectional view of the glue-stopping element for the glue-coating device in accordance with the present invention; and

FIG. 6 is an operational view in partial cross section of a conventional glue-coating device.

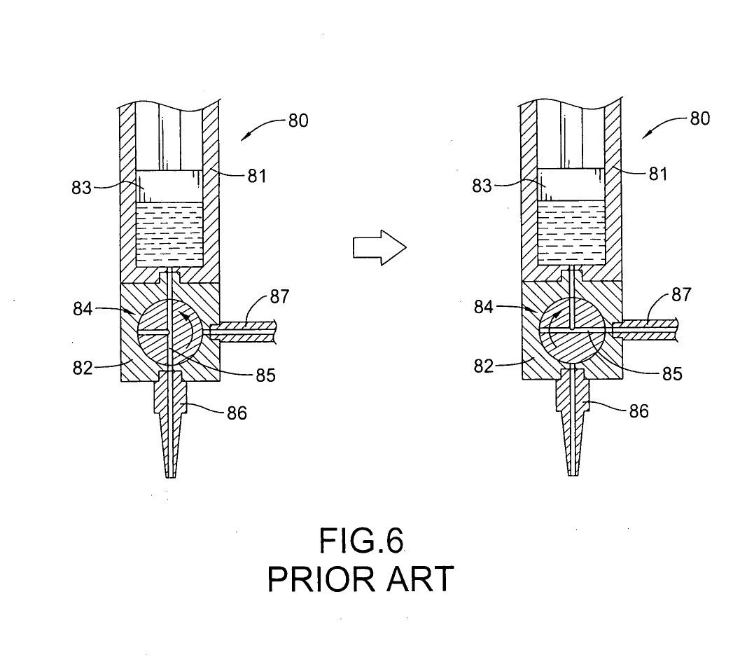

### DETAILED DESCRIPTION OF THE PREFERRED EMBODIMENT

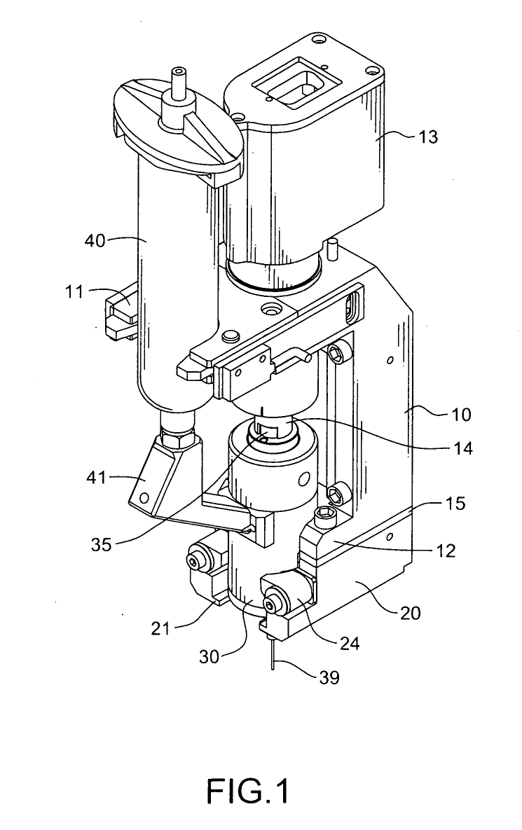

With reference to FIGS. 1-4, a glue-coating device comprises a seat (10), a base (20), a nozzle assembly (30), a driving element, and a barrel (40). The seat (10) is mounted on the base (20). The nozzle assembly (30) is held in a front end of the base (20) and the barrel (40) is held in a front end of the seat (10).

A first set of supporting arms (11) extends out of the front of an upper end of the seat (10) to support the barrel (40). A second set of supporting arms (12) extends out of the lower end of the seat (10) to form a chamber wherein the nozzle assembly (30) is received. A motor (13) is mounted on the upper end of the seat (10). An upper shaft (14) connects to the shaft of the motor (13) and extends downwards into the chamber. A heat isolation plate (15) is provided between the seat (10) and the base (20). The barrel (40) is connected to the nozzle assembly (30) through a tube (41) provided at the front end of the seat (10). Two shoulders (21) are formed in the base (20) at the lower end of the chamber to support the nozzle assembly (30). Two projections (24) extend out of the front end of the base (20) to clamp the nozzle assembly (30) on both sides, respectively. A lower shaft (35) is mounted in an upper end of the nozzle assembly (30) and is connected to the upper shaft (14).

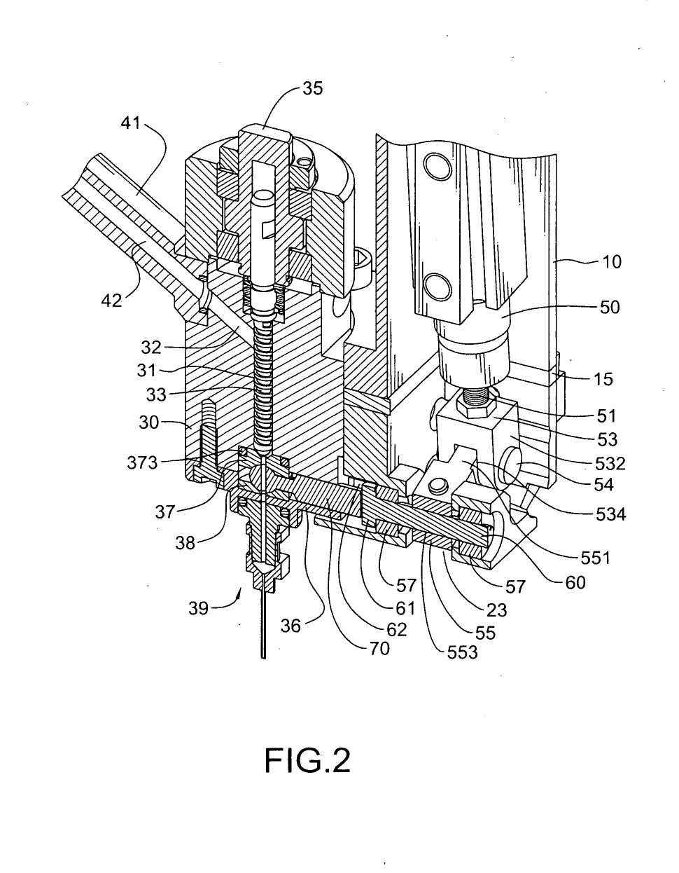

With reference to FIGS. 1-2, the nozzle assembly (30) comprises a vertical passage (31) axially defined therein, and a skewed passage (32) defined therein and connected to an upper end of the vertical passage (31). A feed passage (42) is defined in the tube (41) and connected to the skewed passage (32). A threaded shaft (33) is mounted in the vertical passage (31) and an upper end of the threaded shaft (33) is securely fastened to the lower axle (35). The glue in the barrel (40) flows down into the feed passage (42), through the skewed passage (32) and then into the vertical passage (31). The motor (13) turns the threaded shaft (33), through the upper axle (14) and the lower axle (35), which pushes the glue down the vertical passage (31).

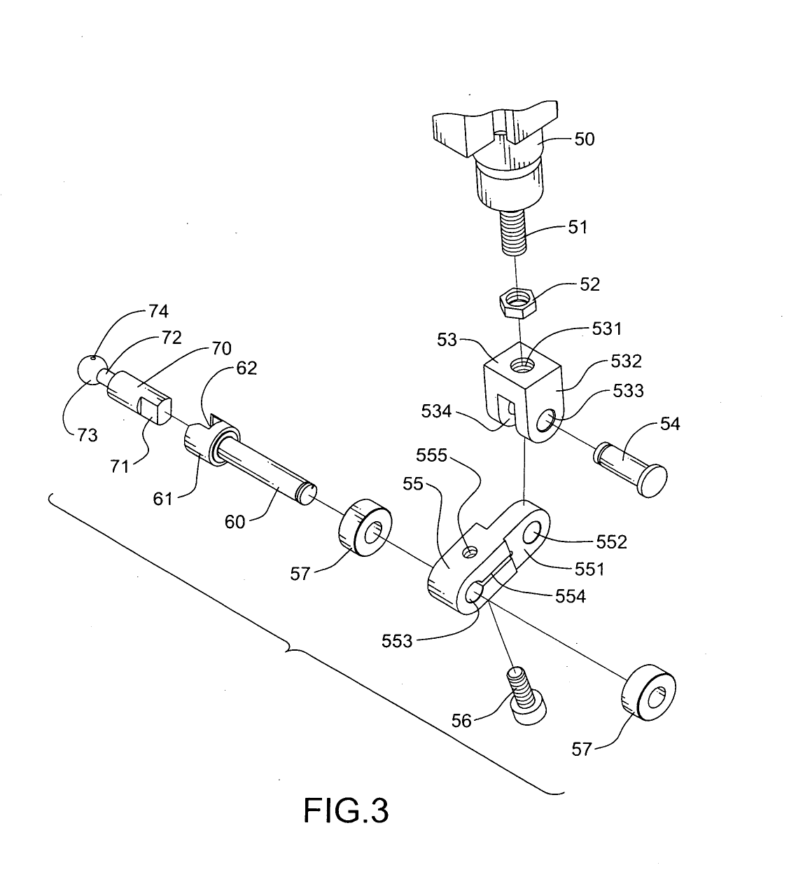

With further reference to FIG. 2-3, a glue-stopping element for a glue-coating device in accordance with the present invention is mounted between the base (20) and the seat (10) and comprises a driver element and a ball valve (73). The ball valve (73) has a through hole (74) defined in a center thereof. An upper splint (37) and a lower splint (38) are mounted in a lower end of the nozzle assembly (30) to receive the ball valve (73) and can be made of polytetrafluoroethylene (Teflon).

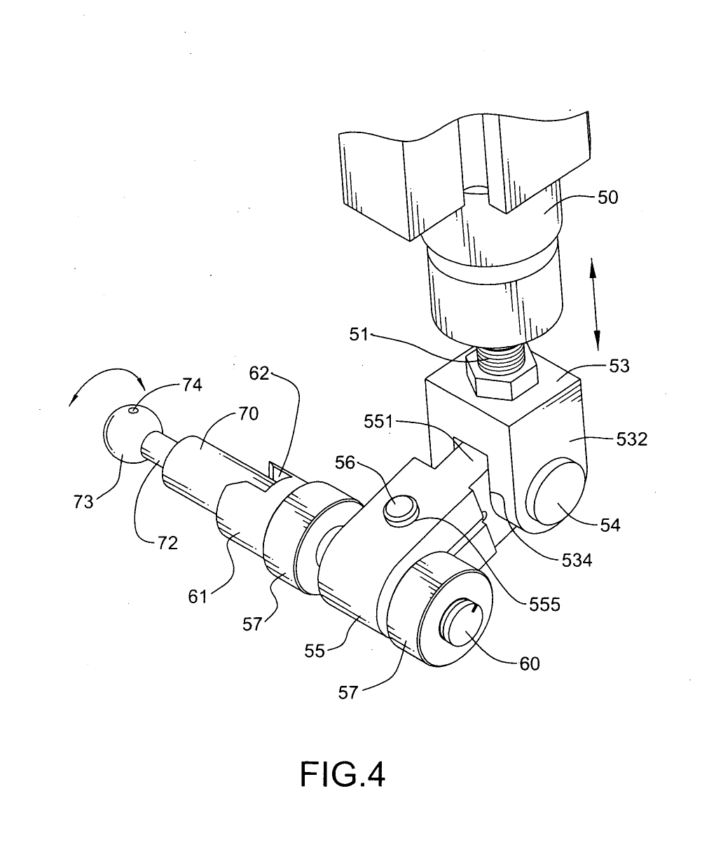

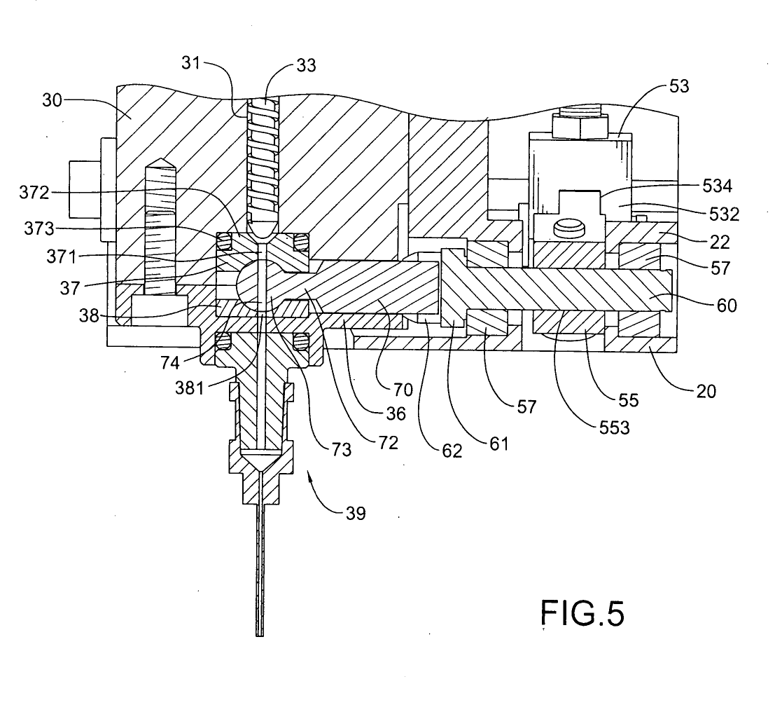

With further reference to FIGS. 4 and 5, the driver element has a pneumatic actuator (50), an actuating arm, a driving rod assembly and a shell (22). The pneumatic actuator (50) is mounted in the seat (10) and has a threaded end (51). The actuating arm comprises a U-shaped block (53) and an arm (55). The U-shaped block (53) has a base and two extended sides (532), which define a channel (534). The base has a first orifice (531), which is threaded, and the two extended sides (532) each have a second orifice (533). The U-shaped block (53) is connected to the threaded end (5 1) of the pneumatic actuator (50) through the threaded first orifice (531) and a retaining nut (52). The arm (55) has a connecting end (551), which is narrower than the remainder of the aim (55). An aperture (552) is defined in the center of the connecting end (551) and an opening (553) is defined in the center of the opposite end of the arm (55). A slot (554) is defined adjacent to and in communication with the opening (553). A threaded aperture (555) is defined in a top end of the arm (55) and in communication with the slot (554). The connecting end (551) is inserted into the channel (534) and pivotally connected to the U-shaped block (53) with a pin (54) through the second orifices (533) and the aperture (552).

The driving rod assembly has a first driving rod (60) and a second driving rod (70). The first driving rod (60) has a head (61) integrally formed in an end thereof and a groove (62), which is defined in the head (61). The second driving rod (70) has flats (71) formed at a first end thereof to be inserted into the groove (62), and a neck (72) formed at the opposite end. The ball valve (73) is mounted on the neck (72).

With further reference to FIGS. I and 2, the shell (22) is mounted at the bottom of the base (20) and two bearings (57) are mounted respectively in two sides of the shell (22). The arm (55) is received into the shell (22). The first driving rod (60) is then inserted into the shell (22) through the bearings (57) and the opening (553). When the first driving rod (60) is inserted through the opening (553), a set screw (56) is used in the threaded aperture (555) to secure the first driving rod (60) to the arm (55). With reference to FIG. 4, the first driving rod (60) and the second driving rod (70) of the driving assembly are alternately rotated back and forth by the pneumatic actuator (50) through the actuating arm.

With reference to FIGS. 2 and 5, a housing is defined in a lower end of the nozzle assembly (30) wherein the second driving rod (70) is received. A bottom plate (36) is mounted on the lower end of the nozzle assembly (30) to support the second driving rod (70). A needle-nose nozzle (39) is mounted in the lower end of the nozzle assembly (30). The upper splint (37) and the lower splint (38) have concave inner walls to clasp the ball valve (73). A ring holder (372) is integrally formed on an upper end of the upper splint (37) and a biasing ring (373) is mounted around the ring holder (372). A first through hole (371) is defined in the upper splint (37) and a second through hole (381) is defined in the lower splint (38). Both the first through hole (371) and the second through hole (381) are aligned with the hole (74).

In the process of glue coating, the glue in the vertical passage (31) is driven by the rotation of the threaded shaft (33) and pushed into the first through hole (371), the hole (74) and the second through hole (381) in turn and out of the needle-nose nozzle (39). With the reciprocating movement of the pneumatic actuator (50), the driving rod assembly is alternately rotated clockwise and counter-clockwise, and in turn, bringing the hole (74) in the ball valve (73) alternately in and out of alignment with the first through hole (371) and the second through hole (381) to achieve a glue-stopping effect.

When the ball valve (73) becomes worn or damaged due to extended use, the upper splint (37) will remain abutted to the ball valve (73) due to pressure from the biasing ring (373) and prevent the glue from overflowing into the periphery of the ball valve (73).

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A glue-stopping element for a glue-coating device having a base, a seat, and a nozzle assembly, wherein the glue-stopping element is mounted between the base and the seat of the glue-coating device and comprises:
a driver element;
a ball valve operatively connected to and driven by the driver element and having a hole defined in a center thereof; and
an upper splint and a lower splint mounted around the ball valve to receive the ball valve.

2. The glue-stopping element for a glue-coating device as claimed in claim 1, wherein the driver element has
a pneumatic actuator with a threaded end;
an actuating arm securely attached to the threaded end of the pneumatic actuator and comprising
a U-shaped block, having a base with a threaded first orifice engaging with the threaded end on the pneumatic actuator and two extended sides, each with a second orifice, forming a channel thereby, and
an arm having a narrow connecting end with an aperture connected to the U-shaped block, an opening in an end opposite to the narrow connecting end, an adjacent slot communicating with the opening and a threaded aperture communicating with the slot;
a driving rod assembly connected with the arm of the actuating arm and having
a first driving rod connected to and extending through the opening in the arm of the actuating arm and formed with an integrated head at an end wherein a groove is defined, and
a second driving rod connected to the groove in the first driving rod and having flats formed at an end of the second driving rod to mate with the groove in the first driving rod and a neck formed at an end opposite to the flats, wherein the ball valve is mounted on the neck.

3. The glue-stopping element for a glue-coating device as claimed in claim 2, wherein the U-shaped block of the driving element is mounted on the threaded end of the pneumatic actuator through the threaded first orifice and secured with a retaining nut.

4. The glue-stopping element for a glue-coating device as claimed in claim 3, wherein the connecting end of the arm is inserted into the channel in the U-shaped block and pivotally mounted with a pin through the two second orifices and the aperture.

5. The glue-stopping element for a glue-coating device as claimed in claim 4 further comprising a shell wherein two bearings are mount at two ends, wherein the shell is adapted to be mounted in the base of the glue-coating machine, the arm is received into the shell and the first driving rod is inserted through the bearings and the opening and secured to the arm with a set screw through the threaded aperture.

6. The glue-stopping element for a glue-coating device as claimed in claim 5, wherein
the upper splint and the lower splint, respectively have concave inner walls to clasp the ball valve and made of polytetrafluoroethylene (Teflon);
the upper splint further has a ring holder integrally formed on the upper splint; and
a biasing ring mounted around the ring holder.

7. The glue-stopping element for a glue-coating device as claimed in claim 6, wherein a first through hole is defined in the upper splint and a second through hole is defined in the lower splint, and both the first through hole and the second through hole are respectively configured to align with the hole in the ball valve.
